(19) United States
(12) Patent Application Publication
(10) Pub. No.: US 2013/0161222 A1
(43) Pub. Date: Jun. 27, 2013

(54) BEDBUGS ELIMINATOR

(71) Applicant: Ajit M. Patel, South Plainfield, NJ (US)

(72) Inventor: Ajit M. Patel, South Plainfield, NJ (US)

(21) Appl. No.: 13/287,002

(22) Filed: Dec. 21, 2011

(51) Int. Cl. B65D 85/84; A01P 7/04; A01N 37/44

(52) U.S. Cl. 206/524.5; 514/620

(57) ABSTRACT

This product is made of composition of Paraffin Oil (Kerosene) and 40% Solution of Denatonium Benzoate in EG. The content of Paraffin Oil would be 90% and 10% of 40% Soln. of D. B. E. G.

The product can be used with spray bottles in residential and commercial places where Bed Bugs are found. The composition of these three chemicals are capable to eliminate the Bed Bugs and their eggs by applying in the affected area for few weeks or until they are completely eliminated. Normally, these chemical will work as a wonder chemical pesticide very effectively. There is no known side effect of these chemicals.

| Product: 40% Denatonium Benzoate | | |
|---|---|---|
| in Mono Ethylene | | |
| Glycol Solution (w/w) | Date of Report: Nov. 15^{th} 2011 | |
| Batch No.: 5020/Liq. | Manu. Date: Nov. 14^{th} 2011 | |
| Sample Received: Final Product (Bulk) | Test for: XXXXXX | |
| Batch Quantity: 4000 Kg. | Buyers Reference: 1262/XXXXX | |
| TEST: | RESULTS: | |
| Appearance | Water white to pale yellow color | |
| Assay (wt %) | 40.1% Denatonium Benzoate | |
| | 60% Mono Ethylene Glycol | |
| Identity | Viscous Liquid | |
| pH (3% Solution) | pH 7.2 | |
| Sulfated Ash | 0.02% | NMT 0.1% |
| Chloride | 0.2% | NMT 0.2% |

### SPECIFICATION FOR KEROSENE

Kerosene meets BS 2869: Part 2: 1998 Classification C2

| Fuel Parameters: | British Standard: | Typicals: |
|---|---|---|
| Specification Parameters: | | Max |
| Kinematic Viscosity (cSt at 40° C.) | 1.0 Min\2.00 Max | Max |
| Density at 15° C. 9 (Kg.Litre) | 0.820 | 0.804 |
| Flash Point (° C.) Closed Abel | 38 | 43 |
| Sulphur (% Mass) | 0.2 | 0.04 |
| Water (% Volume) | — | Negligible |
| Smoke Point (MM) | 19 | 21 |
| Char Value (Mg/Kg) | 15 | 8 |

Additional Data: Typical Values and not part of the Specification

| | |
|---|---|
| Gross Specific Energy (MJ/Kg) | 46.2 |
| (MJ/Litre) | 37.1 |
| Mean Specific Heat Capacity Over | 2.09 |
| Range 0-100° C. (kJ/Kg ° C. | |
| Volume Correction Factor (Per ° C.) | 0.00090 |

### Recommendations for the Storages of Kerosene

Many of the problem which may arise during the storage of kerosene can easily be prevented by good housekeeping which should include:
Regular draining of tanks to remove water, so helping to prevent the possibility of microbiological contamination.
Periodic inspection of the tanks for evidence of corrosion.
Periodic internal cleaning of tanks to remove any accumulated sludge.
Avoidance of translucent plastic tanks for storage purposes.

This product is made of composition of Paraffin Oil (Kerosene) and 40% Solution of Denatonium Benzoate in EG. The content of Paraffin Oil would be 90% and 10% of 40% Soln. of D. B. E. G.

The product can be used with spray bottles in residential and commercial places where Bed Bugs are found. The composition of these three chemicals are capable to eliminate the Bed Bugs and their eggs by applying in the affected area for few weeks or until they are completely eliminated. Normally, these chemical will work as a wonder chemical pesticide very effectively. There is no known side effect of these chemicals.

Direction: Fill up the Spray Bottle and spray in the area or take in small pan and apply with 3″-4″ paint brush. Precaution: When applying, one must use gloves, mask and protected lenses. Kids or adults should not stay in the area for at least 3-4 hours after it is applied to the affected area. Then windows can be opened to let the smell go away.

Packaging Method: It can packed in HDPE and Steel Containers or Bottles.

1. I would like to claim this invention as my claim 1 for this invention.
